(19) United States
(12) Patent Application Publication
(10) Pub. No.: US 2010/0266478 A1
(43) Pub. Date: Oct. 21, 2010

(54) Metal Nano Catalyst, Method for Preparing the Same and Method for Controlling the Growth Types of Carbon Nanotubes Using the Same

(75) Inventors: Byeong Yeol KIM, Uiwang-si (KR); Seung Yong BAE, Uiwang-si (KR); Young Sil LEE, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/627,063

(22) Filed: Nov. 30, 2009

(30) Foreign Application Priority Data
Dec. 10, 2008 (KR) 2008-125453

(51) Int. Cl. D01F 9/12; B01J 21/04; B01J 21/08; B01J 21/10

(52) U.S. Cl. 423/447.1; 502/247; 502/255; 502/313; 502/315; 502/316; 502/328; 502/335; 502/336; 502/332; 977/742; 977/902; 977/843

(57) ABSTRACT

The present invention provides a metal nano catalyst, a method for preparing the same and a method for controlling the growth types of carbon nanotubes using the same. The metal nano catalyst can be prepared by burning an aqueous metal catalyst derivative comprising Co, Fe, Ni or a combination thereof in the presence of a supporting body precursor.

### CROSS REFERENCE TO RELATED APPLICATIONS

This application claims priority from Korean Patent Application No. 2008-125453 filed on Dec. 10, 2008 in the Korean Intellectual Property Office, the disclosure of which is incorporated herein by reference in its entirety.

### FIELD OF THE INVENTION

The present invention relates to a metal nano catalyst, a method for preparing the same and a method for controlling the growth types of carbon nanotubes using the same.

### BACKGROUND OF THE INVENTION

Recently, there has been much research and development of carbon nanotubes (hereinafter CNT). Engineering plastic composites including carbon nanotubes can have electro-conductivity and accordingly can be used as a high value-added material for shielding electromagnetic waves, preventing static electricity, and the like. The electro-conductivity achieved by adding carbon nanotubes to a plastic composite can be influenced by manufacturing conditions, the resin employed, and the characteristics of the carbon nanotubes themselves such as purity, diameter, and growth type. Higher electrical characteristics can be achieved when using shorter diameter carbon nanotubes which are less likely to lump together and/or tangle as longer diameter carbon nanotubes.

Generally, graphite can be rolled into a cylinder to form the faces of a carbon nanotube. The carbon nanotubes are classified into single-walled carbon nanotubes, double-walled carbon nanotubes and multi-walled carbon nanotubes according to the number of rolled surfaces of the cylinder, and have different properties according to the number of such walls. For example, single-walled or double-walled carbon nanotubes can have high electrical characteristics and accordingly are widely used in devices such as electronic emitting devices, electronic device elements, sensors, and the like. Multi-walled carbon nanotubes can have lower electro conductivity but can be used in high strength complex materials due to the high physical properties thereof. The development of a manufacturing process which mass-produces high purity carbon nanotubes at a lower cost is important for successful utilization of these carbon nanotubes in various industrial fields.

Carbon nanotubes are mainly synthesized by electro-discharge method, laser ablation, high pressure vapor deposition, normal pressure thermal chemical vapor deposition, and the like. Electro-discharge methods and laser ablation can be easy to apply due to the simple principals thereof but are not adequate for mass production and the product produced thereby can include many impurities. Thermal chemical vapor deposition is currently the most useful method to mass-produce high purity carbon nanotube at lower costs.

When manufacturing carbon nanotubes by thermal chemical vapor deposition, the catalyst used is also important and is generally a transition metal such as cobalt, iron, nickel, and the like supported by a supporting body. Methods for synthesizing a catalyst for manufacturing carbon nanotubes includes co-precipitation methods, impregnation methods, combustion methods, and other various methods. The final catalyst can be prepared by heat treatment at a high temperature of about 500 to about 1200° C.

The electro-conductivity exhibited by CNTs in a high polymer composite is largely influenced by even distribution of CNTs in a high polymer matrix as well as the electrical property of the CNTs. The degree of CNT distribution may be influenced by the growth type of the CNTs. Generally, a bundle (treads) type is more easily distributed in a high polymer matrix and accordingly can exhibit higher electro-conductivity than a cotton (a lump) type. However CNT growth type regulation technology has not been studied systematically and is not yet organized theoretically.

### SUMMARY OF THE INVENTION

The present inventors have developed a method for regulating or controlling carbon nanotube growth type by changing the composition of a metal catalyst for carbon nanotube synthesis, a metal nano catalyst with a new composition, and a method for manufacturing the metal nano catalyst which can save time and cost compared with other manufacturing methods.

An aspect of the present invention provides a metal nano catalyst with a new composition.

Another aspect of the present invention provides a metal nano catalyst which can regulate carbon nanotube growth type.

Another aspect of the present invention provides a metal nano catalyst which can regulate carbon nanotube diameter.

Another aspect of the present invention provides a method of manufacturing a metal nano catalyst, which method can be stable.

Another aspect of the present invention provides a carbon nanotube of bundle growth type or cotton growth type.

Another aspect of the present invention provides a method for manufacturing carbon nanotubes which can be used to mass produce carbon nanotubes and can save time and cost.

Another aspect of the present invention provides a new method which can regulate the growth type of carbon nanotubes.

Other aspects, features and advantages of the present invention will be apparent from the ensuing disclosure and appended claims.

An aspect of the present invention provides a metal nano catalyst with a new composition.

The metal nano catalyst can have a composition as follows:

(Ni, Co, Fe)ₓ(Mo, Va)_{y}(Al₂O₃, MgO, SiO₂)_{z}

wherein x, y and z are mole ratios and 1≦x≦10, 0≦y≦5, and 2≦z≦15).

Another aspect of the present invention provides a method for manufacturing a metal nano catalyst. The manufacturing method comprises making an aqueous metal catalyst derivative comprising Co, Fe, Ni, or a combination thereof absorbed on the surface of a supporting body comprising Al₂O₃, MgO, SiO₂ or a combination thereof.

In exemplary embodiments, the aqueous metal catalyst derivative may be a metal hydrate. The metal hydrate may include iron (III) nitrate hydrate, nickel nitrate hydrate, cobalt nitrate hydrate, or a combination thereof.

In exemplary embodiments, the efficiency of the catalyst can be increased by promoting metal particle adsorption stability onto a surface of the supporting body using molybdenum (Mo), vanadium (V), or a combination thereof.

In exemplary embodiments, the supporting body may be formed from a precursor compound comprising aluminum nitrate hydrate, magnesium nitrate hydrate, silica nitrate hydrate, or a combination thereof.

In one exemplary embodiment, the manufacturing method may include combustion performed at a temperature of about 300 to about 900° C., for example about 500 to about 600° C.

In exemplary embodiments, the aqueous metal catalyst derivative and the supporting body precursor may be used in an aqueous phase.

Another aspect of the present invention provides a method for regulating or controlling the growth type of carbon nanotubes using the metal nano catalyst. In the method, the mole ratio of the aqueous metal catalyst derivative (x) and the supporting body precursor (z) can be regulated to be x:z=about 1 to about 10:about 2 to about 15 in a process for synthesizing carbon nanotubes which comprises the steps of: preparing a metal nano catalyst using an aqueous metal catalyst derivative comprising Co, Fe, Ni or a combination thereof in the presence of a supporting body precursor; and preparing carbon nanotubes by supplying carbon gas in the presence of the synthesized metal nano catalyst. In another exemplary embodiment, the mole ratio of the aqueous metal catalyst derivative (x) and the supporting body precursor (z) can be x:z=about 1 to about 10:about 7.5 to about 15.

In one exemplary embodiment, the metal particle surface stability of the aqueous metal catalyst derivative and the supporting body precursor can be increased using molybdenum (Mo), vanadium (V), or a combination thereof.

Another aspect of the present invention provides a carbon nanotube synthesized by the manufacturing process. The carbon nanotube can have a bundle growth type or a cotton growth type.

### BRIEF DESCRIPTION OF THE DRAWINGS

FIGS. 1-6 are scanning electron microscopic (SEM) images of carbon nanotubes (CNTs) prepared in accordance with Examples 1-6, respectively.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The metal nano catalyst of the present invention has a new composition as follows:

(Ni, Co, Fe)ₓ(Mo, Va)_{y}(Al₂O₃, MgO, SiO₂)_{z}

wherein x, y and z are mole ratios and 1≦x≦10, 0≦y≦5, and 2≦z≦15. In one exemplary embodiment, 1≦x≦7, 0≦y≦1.5, and 2≦z≦7.5. In another exemplary embodiment, 1≦x≦7, 0≦y≦1.5, and 7.5≦z≦15. In another exemplary embodiment, 1≦x≦3, 0≦y≦1.5, and 2≦z≦15.

As used herein, the formula of the composition

(Ni, Co, Fe)ₓ(Mo, Va)_{y}(Al₂O₃, MgO, SiO₂)_{z}

will be understood to include (Ni or Co or Fe or a combination thereof)ₓ(Mo or Va or a combination thereof)_{y}(Al₂O₃ or MgO or SiO₂ or a combination thereof)_{z}.

The metal nano catalyst can be useful for carbon nanotube synthesis. When using the metal nano catalyst for carbon nanotube synthesis, as the value of z is increased compared with the value of x, a bundle type carbon nanotube can be readily synthesized, and as the value of z is lowered, a cotton type carbon nanotube can be readily synthesized.

In one exemplary embodiment, the metal nano catalyst of the present invention has the structure in which metal particles including Co, Fe, Ni, or a combination thereof are evenly distributed and absorbed on the surface of Al₂O₃, MgO, SiO₂, or a combination thereof, and as another example, on the surface of Al₂O₃.

The metal nano catalyst of the composition can be synthesized by absorbing an aqueous metal catalyst derivative which includes Co, Fe, Ni, or a combination thereof onto the surface of a supporting body comprising Al₂O₃, MgO, SiO₂ or a combination thereof and thermally treating the same. In one exemplary embodiment, the metal nano catalyst can be synthesized by the steps of: preparing an aqueous solution of a metal catalyst derivative and an aqueous solution of a supporting body precursor, respectively, by dissolving an aqueous metal catalyst derivative including Co, Fe, Ni, or a combination thereof and a supporting body precursor into a separate aqueous solution, respectively; preparing a mixed aqueous solution by mixing the separate aqueous solutions; and burning the mixed aqueous solution.

In exemplary embodiments, the aqueous metal catalyst derivative may include a metal hydrate. Examples of the metal hydrate may include without limitation iron (III) nitrate hydrate, nickel nitrate hydrate, cobalt nitrate hydrate, and the like, and combinations thereof. The aqueous metal catalyst derivative can further include any derivative which can be dissolved into water or an alcohol based solvent such as methanol, ethanol, isopropanol, and the like in addition to the metal nitrate hydrate.

In exemplary embodiments, the metal nano catalyst may be synthesized in the presence of an activator such as but not limited to molybdenum (Mo), vanadium (V) or combination thereof. The molybdenum (Mo) or vanadium (V) may be molybdenum hydrate or vanadium hydrate, respectively. The activator may be applied in the form of an aqueous solution. The activator can also act as a stabilizer which can help stabilize the metal catalyst derivative on the surface of the supporting body. The use of molybdenum (Mo) or vanadium (V) can prevent lumping of nano-size metal catalyst during metal particle burning at high temperatures. In addition, CNT diameter can be decreased, high yield can be achieved, and the growth type of CNT can be a cotton type if molybdenum (Mo) or vanadium (V) is used with the catalyst in carbon nanotube synthesis.

Exemplary supporting bodies may include without limitation magnesium oxide, aluminum oxide, zeolite, and the like, and combinations thereof.

In one exemplary embodiment, an activator such as citric acid may be added to make synthetic reaction of metal nano catalyst facile. The citric acid may be added in a mole-ratio of about 2 to about 15. Other examples of the activator include but are not limited to: tartaric acid, polyethylene glycol, and the like as well as citric acid, and combinations thereof.

The aqueous metal catalyst derivative and the supporting body precursor may be prepared by burning. The burning can be conducted under conditions to remove solvent (perform solution dryness) and promote metal particle calcination at the same time and to synthesize a large quantity of catalyst in a short time. The method can also distribute and attach metal particles evenly on the surface of a supporting body. In exemplary embodiments, the metal nano catalyst mixed solution including the aqueous metal catalyst derivative and the supporting body precursor is heated in air at a temperature of about 300 to 900° C., for example at about 450 to 600° C. for about 15 minutes to about 3 hours, for example about 30 minutes to about 1 hour.

The final metal nano catalyst can be prepared by pulverization after calcination by the heat treatment. The synthesized metal nano catalyst can be in powder form.

Another aspect of the present invention provides a carbon nanotube synthesized using the metal nano catalyst. In one exemplary embodiment, the carbon nanotube can be synthesized by supplying and reacting carbon gas in the presence of the metal nano catalyst. For example, the carbon gas can be supplied at a temperature of about 600 to about 950° C.

In exemplary embodiments, the carbon nanotube can be synthesized by normal pressure thermal chemical vapor deposition. For example, the metal nano catalyst synthesized in powder form can be placed on a ceramic boat, and the carbon nanotube can be synthesized by supplying carbon gas at a temperature of about 600 to about 950° C. for about 30 minutes to about 1 hour using a fixed bed reactor. In other exemplary embodiments, about 0.01 to about 10 g of the metal nano catalyst synthesized in powder form can be applied evenly on a ceramic boat, and the ceramic boat can be set in the fixed bed reactor. After that, the reactor can be closed to be isolated from the contact with the outside and heated to a reaction temperature of about 600 to about 950° C. at the rate of about 30° C./minute. During heating, inert gas such as nitrogen, argon, and the like can be injected in amount of about 100 to about 1000 sccm (standard cubic centimeter per minute), for example about 200 to about 500 sccm to remove oxygen remaining in the reactor. When the temperature reaches at the reaction temperature, the injection of inert gas is stopped and synthesis is started by injecting carbon gas in amount of about 20 to about 500 sccm, for example about 50 to about 200 sccm. The carbon nanotube can be synthesized by supplying carbon gas for about 30 minutes to about 2 hours, for example about 30 minutes to about 1 hours of synthetic time.

The carbon gas may be hydrocarbon gas such as methane, ethylene, acetylene, LPG, and the like, and combinations thereof.

The present invention can mass-produce carbon nanotubes continuously which can regulate the growth type thereof by changing the composition of the metal catalyst in the nano-size metal catalyst supported on a supporting body. Stated differently, the growth type of carbon nanotubes can be regulated by changing the composition of elements included in the catalyst.

The present invention provides a method for regulating the growth type of carbon nanotubes using the metal nano catalyst. The regulation method has the characteristic that the mole ratio of the aqueous metal catalyst derivative (x) and the supporting body precursor (z) is regulated to be x:z=about 1 to about 10:about 2 to about 15 in a process of synthesizing carbon nanotubes which comprises the steps of: preparing a metal nano catalyst using an aqueous metal catalyst derivative comprising Co, Fe, Ni, or a combination thereof in the presence of a supporting body precursor; and preparing carbon nanotubes by supplying carbon gas in the presence of the synthesized metal nano catalyst.

In one exemplary embodiment, the mole ratio of the aqueous metal catalyst derivative (x) and the supporting body precursor (z) is x:z=about 1 to about 10:about 2 to about 7.5. In another exemplary embodiment, the mole ratio of the aqueous metal catalyst derivative (x) and the supporting body precursor (z) is x:z=about 1 to about 10:about 7.5 to about 15. The mole ratio (x) may be in the range of about 1 to about 7, about 1 to about 5 or about 1 to about 3.

In exemplary embodiments, non-limiting examples of the supporting body may include magnesium oxide, aluminum oxide, zeolite, and the like, and combinations thereof, for example aluminum oxide.

In one exemplary embodiment, the aqueous metal catalyst derivative and the supporting body precursor may be burned in the presence of molybdenum (Mo) activator, vanadium (V) activator, or a combination thereof.

Another aspect of the present invention provides a carbon nanotube synthesized by the method of the invention. The growth type of the carbon nanotube may be bundle type or cotton type.

The invention may be better understood by reference to the following examples which are intended to illustrate the present invention and do not limit the scope of the present invention, which is defined in the claims appended hereto.

### EXAMPLES

### Example 1

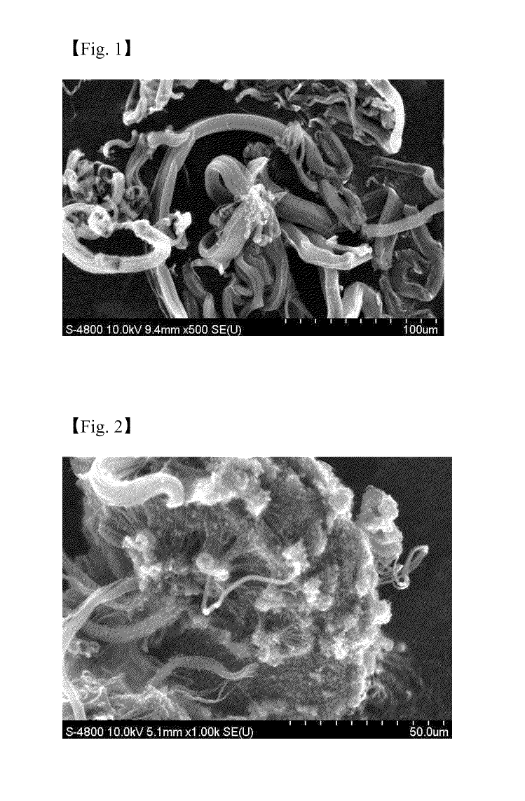

An aqueous solution of a metal catalyst derivative is prepared by dissolving 2.0 mole ratio of iron (III) nitrate hydrate (Fe(NO₃)₃.9H₂O) and 2.0 mole ratio of cobalt nitrate hydrate (Co(NO₃)₂.6H₂O) to 20 ml of water, and an aqueous solution of the supporting body precursor is prepared separately by dissolving 7.5 mole ratio of aluminum nitrate hydrate (Al(NO₃)₃.9H₂O) and 7.5 mole ratio of citric acid (C₆H₁₀O₈) activator to 150 ml of water. Then a catalytic composite solution is prepared by mixing the aqueous solution of metal catalyst derivative and the aqueous solution of the supporting body precursor, and a catalyst is synthesized by heating the catalytic composite solution at a temperature of about 550° C. and atmospheric pressure for about 35 minutes. About 0.03 g of the catalyst synthesized is put on a ceramic boat of fixed bed reactor, and a carbon nanotube can be synthesized by supplying 100/100 sccm of C2H4/H2 at a temperature of about 700° C. for about 1 hour. The CNT synthesized shows bundle type and the Scanning Electron Microscopic (SEM) image of the CNT is represented in FIG. 1.

### Example 2

An aqueous solution of a metal catalyst derivative is prepared by dissolving 2.0 mole ratio of iron (III) nitrate hydrate (Fe(NO₃)₃.9H₂O) and 2.0 mole ratio of cobalt nitrate hydrate (Co(NO₃)₂.6H₂O) to 20 ml of water, and 1.0 mole ratio of molybdenum hydrate ((NH₄)₆Mo₇O₂₄.4H₂O) is dissolved to 10 ml of water separately. 15.0 mole ratio of aluminum nitrate hydrate (Al(NO₃)₃.9H₂O) is dissolved to 140 ml of water to synthesize an aqueous solution of the supporting body precursor. A catalyst is prepared in the same manner as in Example 1 except that a catalytic composite solution is prepared by mixing the above solutions well. The CNT synthesized shows both bundle and cotton type and the Scanning Electron Microscopic (SEM) image of the CNT is represented in FIG. 2.

### Example 3

An aqueous solution of a metal catalyst derivative is prepared by dissolving 2.0 mole ratio of iron (III) nitrate hydrate (Fe(NO₃)₃.9H₂O) and 2.0 mole ratio of cobalt nitrate hydrate (Co(NO₃)₂.6H₂O) to 20 ml of water, and 1.0 mole ratio of molybdenum hydrate ((NH₄)₆Mo₇O₂₄.4H₂O) is dissolved to 10 ml of water separately. 5.0 mole ratio of aluminum nitrate hydrate (Al(NO₃)₃.9H₂O) is dissolved to 140 ml of water to synthesize an aqueous solution of the supporting body precursor. A catalyst is prepared in the same manner as in Example 1 except that a catalytic composite solution is prepared by mixing the above solutions well. The CNT synthesized shows cotton type and the Scanning Electron Microscopic (SEM) image of the CNT is represented in FIG. 3.

### Example 4

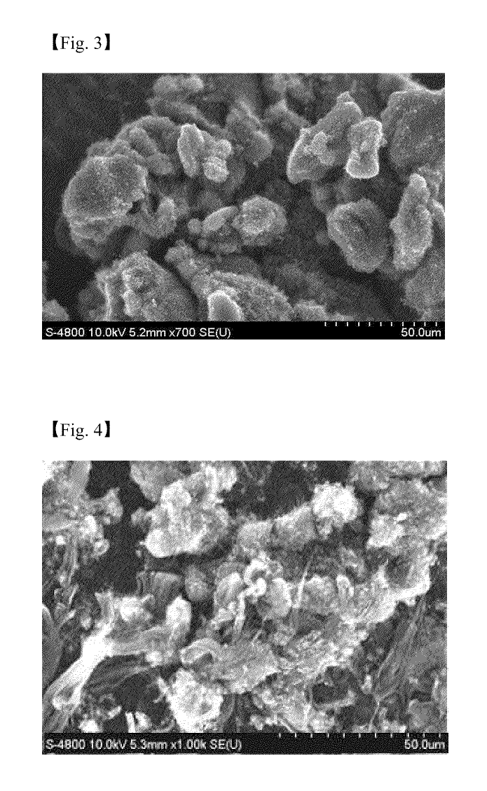

An aqueous solution of a metal catalyst derivative is prepared by dissolving 2.0 mole ratio of iron (III) nitrate hydrate (Fe(NO₃)₃.9H₂O) to 10 ml of water, and 0.1 mole ratio of molybdenum hydrate ((NH₄)₆Mo₇O₂₄.4H₂O) is dissolved to 5 ml of water separately. An aqueous solution of the supporting body precursor is prepared by dissolving 2.5 mole ratio of aluminum nitrate hydrate (Al(NO₃)₃.9H₂O) to 70 ml of water. A catalyst is prepared in the same manner as in Example 1 except that a catalytic composite solution is prepared by mixing the above solutions well. The CNT synthesized shows both bundle and cotton type and the Scanning Electron Microscopic (SEM) image of the CNT is represented in FIG. 4.

### Example 5

An aqueous solution of a metal catalyst derivative is prepared by dissolving 2.0 mole ratio of iron (III) nitrate hydrate (Fe(NO₃)₃.9H₂O) to 10 ml of water, and 0.7 mole ratio of molybdenum hydrate ((NH₄)₆Mo₇O₂₄.4H₂O) is dissolved to 7 ml of water separately. An aqueous solution of the supporting body precursor is prepared by dissolving 2.5 mole ratio of aluminum nitrate hydrate (Al(NO₃)₃.9H₂O) to 70 ml of water. A catalyst is prepared in the same manner as in Example 1 except that a catalytic composite solution is prepared by mixing the above solutions well. When checking the morphology of the CNT synthesized, lump type is shown, and the Scanning Electron Microscopic (SEM) image of the CNT is represented in FIG. 5.

### Example 6

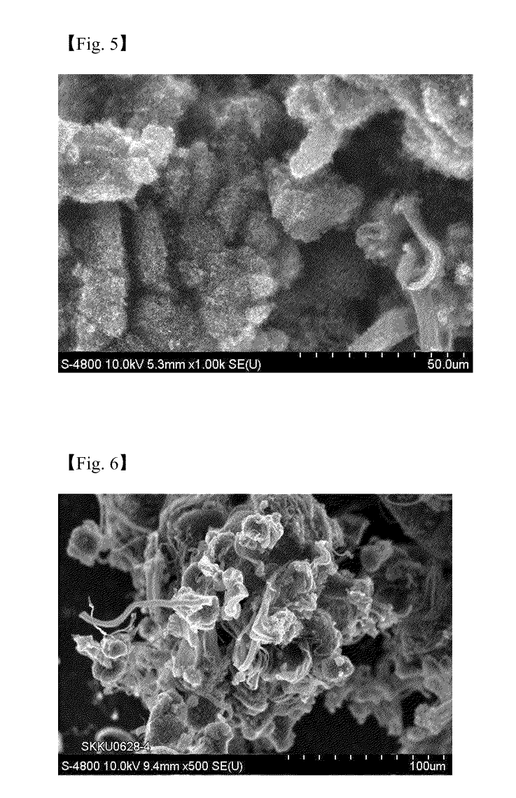

An aqueous solution of a metal catalyst derivative is prepared by dissolving 2.0 mole ratio of iron (III) nitrate hydrate (Fe(NO₃)₃.9H₂O) and 2.0 mole ratio of cobalt nitrate hydrate (Co(NO₃)₂.6H₂O) to 20 ml of water, and 1.0 mole ratio of molybdenum hydrate ((NH₄)₆Mo₇O₂₄.4H₂O) is dissolved to 10 ml of water separately. 7.5 mole ratio of aluminum nitrate hydrate (Al(NO₃)₃.9H₂O) is dissolved to 100 ml of water to synthesize an aqueous solution of the supporting body precursor. A catalyst is prepared in the same manner as in Example 1 except that a catalytic composite solution is prepared by mixing the above solutions well. The CNT synthesized shows bundle type and the Scanning Electron Microscopic (SEM) image of the CNT is represented in FIG. 6.

TABLE 1

| | | Examples | | | | | |
|---|---|---|---|---|---|---|---|
| | | 1 | 2 | 3 | 4 | 5 | 6 |
| Composite | (A)Iron | 2.0 | 2.0 | 2.0 | 2.0 | 2.0 | 2.0 |
| (mole | (B)cobalt | 2.0 | 2.0 | 2.0 | 0 | 0 | 2.0 |
| ratio) | (C)Molybdenum | — | 1.0 | 1.0 | 0.1 | 0.7 | 0.1 |
| | (D)aluminum | 7.5 | 15.0 | 5.0 | 2.5 | 2.5 | 7.5 |
| | oxide | | | | | | |

| | | | | | | |
|---|---|---|---|---|---|---|
| CNT growth type | bundle | bundle | cotton | bundle | cotton | bundle |
| | | and | | and | | |
| | | cotton | | cotton | | |

As shown in Table 1, the growth type of CNT differs according to the content or amount of each component of the metal catalyst. For example, as the content of aluminum oxide increases, the CNT growth type can be a bundle type, not a cotton type. If the content of the supporting body, however, is excessive, the synthetic yields can significantly deteriorate. In addition, as the content of molybdenum increases which can help stabilize the metal catalysts (Fe and Co) on the surface of the supporting body, CNT growth type can be a cotton type, not a bundle type. Increased CNT diameter can also be prevented by minimizing or preventing aggregation of the nano sized metal catalysts during the burning process at a high temperature by controlling the content of molybdenum. Accordingly, the composition of the metal nano catalyst and the supporting body can control the diameter, the synthetic yields, and the growth type of CNT.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A metal nano catalyst having a composition as follows:
(Ni, Co, Fe)ₓ(Mo, Va)_{y}(Al₂O₃, MgO, SiO₂)_{z}
wherein x, y and z are mole ratios and 1≦x≦10, 0≦y≦5, and 2≦z≦15.

2. The metal nano catalyst as claimed in claim 1, wherein the metal nano catalyst has a structure comprising Co, Fe, Ni or a combination thereof absorbed on a surface of Al₂O₃.

3. The metal nano catalyst as claimed in claim 1, wherein the metal nano catalyst synthesizes carbon nanotubes.

4. A method of manufacturing a metal nano catalyst, comprising burning an aqueous metal catalyst derivative including Co, Fe, Ni, or a combination thereof in the presence of a supporting body precursor to provide a metal nano catalyst with a composition as follows:
(Ni, Co, Fe)ₓ(Mo, Va)_{y}(Al₂O₃, MgO, SiO₂)_{z}
wherein x, y and z are mole ratios and 1≦x≦10, 0≦y≦5, and 2≦z≦15.

5. The method of manufacturing a metal nano catalyst as claimed in claim 4, wherein said aqueous metal catalyst derivative is a metal hydrate.

6. The method of manufacturing a metal nano catalyst as claimed in claim 5, wherein said metal hydrate is iron (III) nitrate hydrate, nickel nitrate hydrate, cobalt nitrate hydrate, or a combination thereof.

7. The method of manufacturing a metal nano catalyst as claimed in claim 4, wherein the metal nano catalyst is burned in the presence of a molybdenum (Mo) activator, a vanadium (V) activator, or a combination thereof.

8. The method of manufacturing a metal nano catalyst as claimed in claim 4, wherein said supporting body precursor is an aluminum nitrate hydrate, a magnesium nitrate hydrate, a silica nitrate hydrate, or a combination thereof.

9. The method of manufacturing a metal nano catalyst as claimed in claim 4, wherein the burning is performed at a temperature of about 300 to about 900° C.

10. The method of manufacturing a metal nano catalyst as claimed in claim 4, wherein said aqueous metal catalyst derivative and supporting body precursor are in an aqueous phase.

11. The method of manufacturing a metal nano catalyst as claimed in claim 4, wherein the metal nano catalyst has a structure comprising Co, Fe, Ni, or a combination thereof absorbed on the surface of a supporting body formed from the supporting body precursor.

12. A carbon nanotube prepared using the metal nano catalyst of claim 1.

13. A carbon nanotube prepared using the metal nano catalyst of claim 2.

14. A method for controlling the growth types of carbon nanotubes using a metal nano catalyst in a process of synthesizing carbon nanotubes, comprising the steps of:
preparing a metal nano catalyst using an aqueous metal catalyst derivative (x) comprising Co, Fe, Ni, or a combination thereof in the presence of a supporting body precursor (z), wherein the mole ratio of the aqueous metal catalyst derivative (x) and the supporting body precursor (z) is regulated to be x:z=about 1 to about 10:about 2 to about 15; and
preparing a carbon nanotube by supplying carbon gas in the presence of the synthesized metal nano catalyst.

15. The method as claimed in claim 14, wherein the mole ratio of the aqueous metal catalyst derivative (x) and the supporting body precursor (z) is regulated to be x:z=about 1 to about 10:about 2 to about 7.5.

16. The method as claimed in claim 14, wherein the mole ratio of the aqueous metal catalyst derivative (x) and the supporting body precursor (z) is regulated to be x:z=about 1 to about 10:about 7.5 to about 15.

17. The method as claimed in claim 14, wherein the aqueous metal catalyst derivative and the supporting body precursor is burned in the presence of a molybdenum (Mo) activator, a vanadium (V) activator, or a combination thereof.

18. The method as claimed in claim 14, wherein the metal nano catalyst has a composition as follows:
(Ni, Co, Fe)ₓ(Mo, Va)_{y}(Al₂O₃, MgO, SiO₂)_{z}
wherein x, y and z are mole ratios and 1≦x≦10, 0≦y≦5, and 2≦z≦15.

19. A carbon nanotube having bundle growth type or cotton growth type prepared by the method of claim 14.
